(19) United States
(12) Patent Application Publication
(10) Pub. No.: US 2025/0168705 A1
(43) Pub. Date: May 22, 2025

(54) SYSTEM AND METHOD FOR ULTRA HIGH RELIABILITY (UHR) NULL DATA PACKET ANNOUNCEMENT (NDPA) COMMUNICATIONS

(71) Applicant: NXP USA, Inc., AUSTIN, TX (US)

(72) Inventors: Hari Ram Balakrishnan, Chennai (IN); Liwen Chu, San Ramon, CA (US); Sudhir Srinivasa, Los Gatos, CA (US); Xiayu Zheng, San Jose, CA (US)

(21) Appl. No.: 18/955,138

(22) Filed: Nov. 21, 2024

(30) Foreign Application Priority Data
Nov. 21, 2023 (IN) 202341079076

(51) Int. Cl. H04W 28/18; H04L 5/00; H04W 48/16

(52) U.S. Cl. CPC H04W 28/18; H04L 5/0053; H04W 48/16

(57) ABSTRACT

Embodiments of a method and apparatus for communications are disclosed. In an embodiment, a communications device includes a controller configured to generate a null data packet (NDP) announcement (NDPA) frame carrying a special station (STA) information (info) field, where the special STA info field contains information that indicates the NDPA frame as having an Ultra High Reliability (UHR) NDPA frame format, and a wireless transceiver configured to wirelessly transmit the NDPA frame to a second wireless device.

### CROSS-REFERENCE TO RELATED APPLICATIONS

This application is entitled to the benefit of Indian Provisional Patent Application No. 202341079076, filed on Nov. 21, 2023, the contents of which are incorporated by reference herein.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. Wireless devices compatible with Ultra High Reliability (UHR) and above protocols receive data frames in UHR formats as well as data frames in “Legacy” formats, such as, Extremely High Throughput (EHT) formats.

### SUMMARY

Embodiments of a method and apparatus for communications are disclosed. In an embodiment, a communications device includes a controller configured to generate a null data packet (NDP) announcement (NDPA) frame carrying a special station (STA) information (info) field, where the special STA info field contains information that indicates the NDPA frame as having an Ultra High Reliability (UHR) NDPA frame format, and a wireless transceiver configured to wirelessly transmit the NDPA frame to a second wireless device. Other embodiments are also disclosed.

In an embodiment, the NDPA frame includes STA info fields, and the special STA info field is a first STA info field of the STA info fields.

In an embodiment, the NDPA frame further includes a sounding dialog token field, and the sounding dialog token field includes an NDPA variant subfield.

In an embodiment, the NDPA variant subfield has a value of 3, which indicates the NDPA frame as having either the UHR NDPA frame format or an Extremely High Throughput (EHT) NDPA frame format.

In an embodiment, the NDPA variant subfield has a value of 0, which indicates the NDPA frame as having either the UHR NDPA frame format or a Very High Throughput (VHT) NDPA frame format.

In an embodiment, the special STA info field of the NDPA frame is checked by the second wireless device to determine whether the NDPA frame has a legacy NDPA frame format.

In an embodiment, the special STA info field includes an Association ID (AID) subfield, a version identifier subfield, a multi-AP (MAP) Indication subfield, and a reserved subfield.

In an embodiment, the special STA info field further includes a vendor specific subfield and a Disambiguation (Dis) subfield.

In an embodiment, the AID subfield has a value of 2047.

In an embodiment, the special STA info field includes a vendor specific subfield, a reserved subfield, a Disambiguation (Dis) subfield, a version identifier subfield, and a multi-AP (MAP) Indication subfield.

In an embodiment, the special STA info field includes an Association ID (AID) subfield, a version identifier subfield, a guard interval and long training field subfield, a Physical Layer Protocol Data Unit (PPDU) bandwidth (BW) subfield, a multi-AP (MAP) Indication subfield, a plurality of Disambiguation (Dis) subfields, a reserved subfield, and a Number of user STA Info subfield.

In an embodiment, the special STA info field includes an Association ID (AID) subfield, a partial bandwidth (BW) information subfield, a reserved subfield, a plurality of Number of Column (Nc) Index subfields, a feedback type and Tone/Carrier grouping (Ng) subfield, a codebook size subfield, and a plurality of Disambiguation (Dis) subfields.

In an embodiment, a method for wireless communications involves at a first wireless device, generating a null data packet (NDP) announcement (NDPA) frame carrying a special station (STA) information (info) field, where the special STA info field contains information that indicates the NDPA frame as having an Ultra High Reliability (UHR) NDPA frame format, and from the first wireless device, wirelessly transmitting the NDPA frame to a second wireless device.

In an embodiment, the NDPA frame includes STA info fields, and the special STA info field is a first STA info field of the STA info fields.

In an embodiment, the NDPA frame further includes a sounding dialog token field, and the sounding dialog token field includes an NDPA variant subfield.

In an embodiment, the NDPA variant subfield has a value of 3, which indicates the NDPA frame as having either the UHR NDPA frame format or an Extremely High Throughput (EHT) NDPA frame format.

In an embodiment, the NDPA variant subfield has a value of 0, which indicates the NDPA frame as having either the UHR NDPA frame format or a Very High Throughput (VHT) NDPA frame format.

In an embodiment, the special STA info field of the NDPA frame is checked by the second wireless device to determine whether the NDPA frame has a legacy NDPA frame format.

In an embodiment, the special STA info field includes an Association ID (AID) subfield, a version identifier subfield, a multi-AP (MAP) Indication subfield, and a reserved subfield.

In an embodiment, the special STA info field further includes a vendor specific subfield and a Disambiguation (Dis) subfield.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 illustrates a null data packet (NDP) announcement (NDPA) frame format in accordance with an embodiment of the invention.

FIG. 5 illustrates a Sounding Dialog Token field format in accordance with an embodiment of the invention.

FIG. 6 illustrates a STA info field format in accordance with an embodiment of the invention.

FIG. 7 illustrates an STA info field format in accordance with an embodiment of the invention.

FIG. 8 illustrates a STA info field format in accordance with an embodiment of the invention.

FIG. 9 illustrates a STA info field format in accordance with an embodiment of the invention.

FIG. 10 illustrates a STA info field format in accordance with an embodiment of the invention that can be used in a UHR NDP Announcement frame.

FIG. 11 illustrates a frame control field format of an extended Control frame.

FIG. 12 illustrates an extended control frame format in accordance with an embodiment of the invention.

FIG. 13 illustrates a control information field format in accordance with an embodiment of the invention.

FIG. 14 illustrates a STA info field format in accordance with an embodiment of the invention that can be used in a UHR NDP Announcement frame.

FIG. 15 illustrates a STA info field format in accordance with an embodiment of the invention.

FIG. 16 illustrates a multiple-input multiple-output (MIMO) control field format in accordance with an embodiment of the invention that can be used as a feedback report.

FIG. 17 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In this specification, “UHR & above” format is specified as “UHR” going forward, while “Legacy” format is used to indicate up to EHT format.

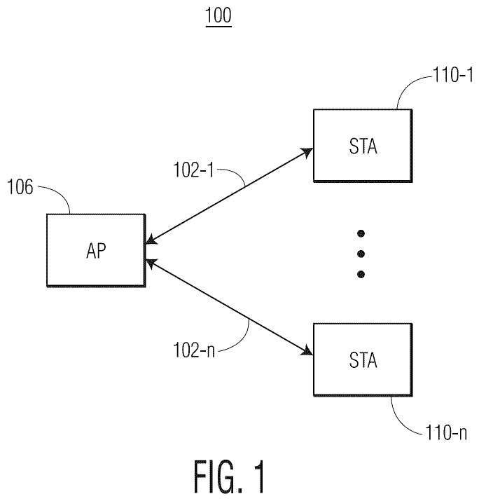

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

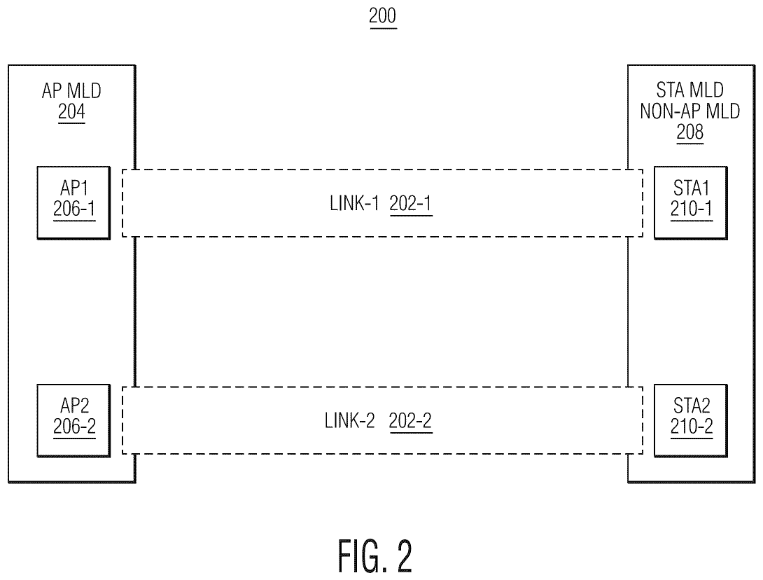

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

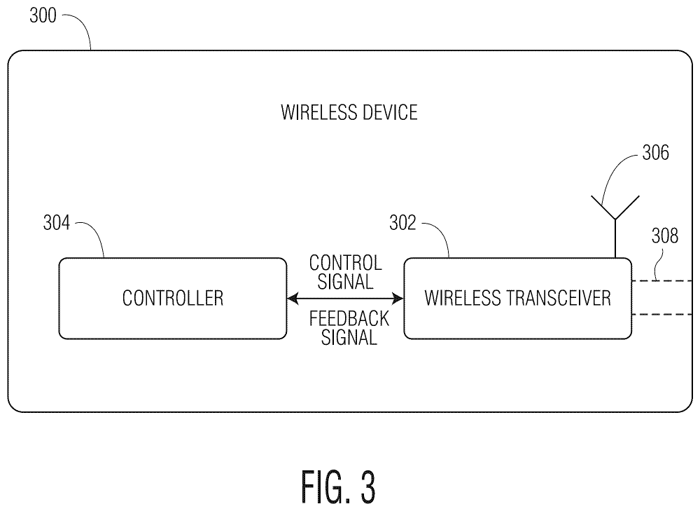

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. The wireless device 300 may be fully or partially implemented as an IC device. In some embodiments, the wireless transceiver 302 and/or the controller 304 may be implemented in a single chip. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 304 is configured to generate a null data packet (NDP) announcement (NDPA) frame carrying a special station (STA) information (info) field, where the special STA info field contains information that indicates the NDPA frame as having an Ultra High Reliability (UHR) NDPA frame format, and the wireless transceiver 302 is configured to wirelessly transmit the NDPA frame to a second wireless device, for example, through the at least one antenna 306. In some embodiments, the NDPA frame include STA info fields, and the special STA info field is the first STA info field of the STA info fields. In some embodiments, the NDPA frame further includes a sounding dialog token field, and the sounding dialog token field includes an NDPA variant subfield. In some embodiments, the NDPA variant subfield has a value of 3, which indicates the NDPA frame as having either the UHR NDPA frame format or an Extremely High Throughput (EHT) NDPA frame format. In some embodiments, the NDPA variant subfield has a value of 0, which indicates the NDPA frame as having either the UHR NDPA frame format or a Very High Throughput (VHT) NDPA frame format. In some embodiments, the special STA info field of the NDPA frame is checked by the second wireless device to determine whether the NDPA frame has a legacy NDPA frame format. In some embodiments, the special STA info field includes an Association ID (AID) subfield, a version identifier subfield, a multi-AP (MAP) Indication subfield, and a reserved subfield. In some embodiments, the special STA info field further includes a vendor specific subfield and a Disambiguation (Dis) subfield. In some embodiments, the AID subfield has a value of 2047. In some embodiments, the special STA info field includes a vendor specific subfield, a reserved subfield, a Disambiguation (Dis) subfield, a version identifier subfield, and a MAP Indication subfield. In some embodiments, the special STA info field includes an AID subfield, a version identifier subfield, a guard interval and long training field subfield, a Physical Layer Protocol Data Unit (PPDU) bandwidth (BW) subfield, a multi-AP (MAP) Indication subfield, Disambiguation (Dis) subfields, a reserved subfield, and a Number of user STA Info subfield. In some embodiments, the special STA info field includes an AID subfield, a partial BW information subfield, a reserved subfield, Number of Column (Nc) Index subfields, a feedback type and Ng (Tone/Carrier grouping) subfield, a codebook size subfield, and Disambiguation (Dis) subfields. In some embodiments, the wireless device 300 or the second communications device includes a wireless access point (AP) or a wireless non-AP station (STA). In some embodiments, the wireless device 300 is compatible with an Institute of Electrical and Electronics Engineers (IEEE) 802.11 protocol. In some embodiments, the wireless device includes a wireless multi-link device (MLD), the second communications device includes a second wireless MLD, and the wireless transceiver 302 is further configured to transmit the NDPA frame for a wireless link to the second wireless MLD through the wireless link between the AP/STA of the wireless MLD in the wireless link and the STA/AP of the second wireless MLD in the wireless link.

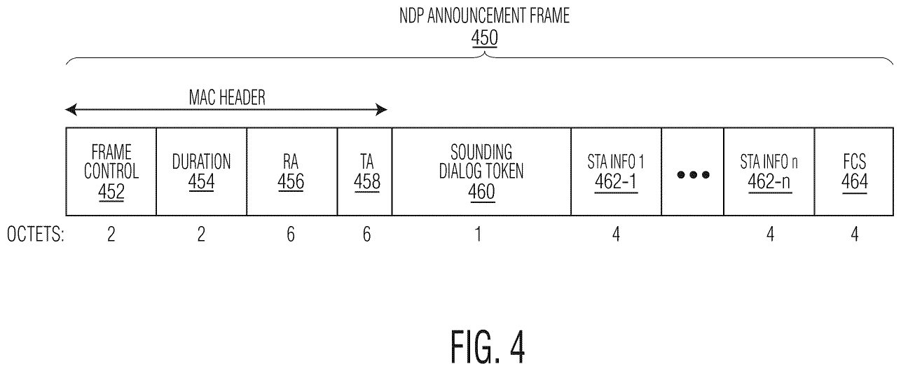

FIG. 4 illustrates a null data packet (NDP) announcement (NDPA) frame format 450 in accordance with an embodiment of the invention. The NDPA frame format 450 illustrated in FIG. 4 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 4, the NDPA frame format 450 includes a frame control field 452 (e.g., two-octet) that may contain frame control information, a frame duration field 454 (e.g., two-octet) that may contain frame duration information, a RA (receiver address) field 456 (e.g., six-octet) that may contain RA address information, a TA (transmitter address) field 458 (e.g., six-octet) that may contain TA address information, a Sounding Dialog Token field 460 (e.g., one-octet) that may contain sounding dialog token information, one or more station (STA) info field 462-1, . . . , 462-n (n being a positive integer) that each (e.g., four-octet) may contain STA information, and a frame check sequence (FCS) field 464 (e.g., four-octet) that may contain FCS information.

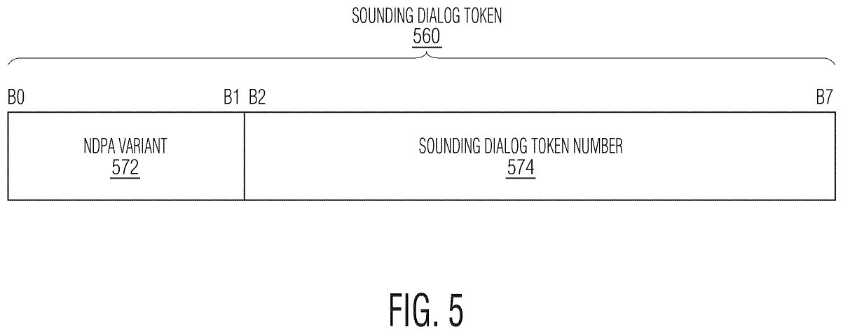

FIG. 5 illustrates a Sounding Dialog Token field format 560 in accordance with an embodiment of the invention. The Sounding Dialog Token field format 560 illustrated in FIG. 5 is an embodiment of the Sounding Dialog Token field 460 illustrated in FIG. 4. However, the Sounding Dialog Token field 460 illustrated in FIG. 4 is not limited to the embodiment shown in FIG. 4. The Sounding Dialog Token field format 560 illustrated in FIG. 5 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 5, the Sounding Dialog Token field format 560 includes an NDPA variant subfield 572 (e.g., two-bit) that may contain NDP announcement variant information and a Sounding Dialog Token number subfield 574 (e.g., six-bit) that may contain sounding dialog token number information. The NDPA variant subfield can be used to distinguish between the different NDPA frames. In Sounding dialog tokens presented in VHT/HE/EHT formats, there is no room for indicating Ultra High Reliability (UHR) NDPA frames. Therefore, there is a need for techniques for defining UHR formats such that data frames in various frame formats can be correctly interpreted by wireless communications devices (e.g., UHR compatible wireless devices). In the embodiment depicted in FIG. 5, the NDPA variant subfield 572 contains NDP announcement variant information that can be used to indicate UHR NDPA frames.

Some UHR NDPA implementation, for example, by the wireless communications system 100 depicted in FIG. 1, the multi-link (ML) communications system 200 depicted in FIG. 2, and/or the wireless device 300 depicted in FIG. 3 are described.

In some embodiments, in Option 1: Sub-option 1, NDPA Variant subfield=0 indicates either “VHT” or “UHR” format. In some embodiments, a special STA info field is used to specify the variant of an NDPA frame for “UHR.”

In some embodiments, in Option 1: Sub-option 2, NDPA Variant subfield=3 indicates either “EHT” or “UHR” format. In some embodiments, a special STA info field is used to specify the variant of an NDPA frame for “UHR.”

In some embodiments, the special STA info field is the first STA info field of an NDPA frame.

In some embodiments, in Option 2, a complete revamp of the NDPA frame format is conducted.

In some embodiments, in Option 1, special STA info variations exist. In some embodiments, if/when a UHR device receives an NDPA frame, the UHR device needs to check for STA info field(s) before deciding the NDPA frame as a legacy NDPA frame format. In some embodiments, the first STA info field is used to indicate the frame as a “UHR” NDPA frame format. Multiple variations of the STA info field are discussed further below.

### Special STA Info Field—Variation 1

In some embodiments, if/when a UHR device receives an NDPA frame, the UHR device needs to check for STA info field(s) before deciding the NDPA frame as a legacy NDPA frame format. In some embodiments, in condition on the special STA info field, the first STA info field for “UHR” device is in EHT STA info field format.

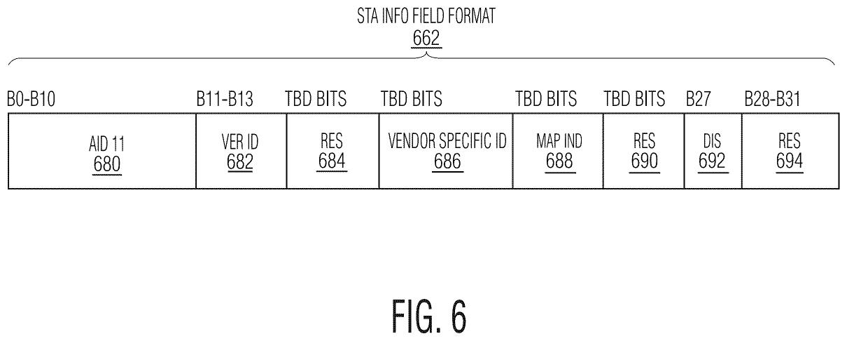

FIG. 6 illustrates a STA info field format 662 in accordance with an embodiment of the invention. The STA info field format 662 illustrated in FIG. 6 may be an embodiment of the first STA info field 462-1 of the NDPA frame format 450 illustrated in FIG. 4. However, the first STA info field 462-1 of the NDPA frame format 450 illustrated in FIG. 4 is not limited to the embodiment shown in FIG. 6. The STA info field format 662 illustrated in FIG. 6 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 6, the STA info field format 662 includes an AID 11 subfield 680 (e.g., eleven-bit) that may contain AID information, a Version Identifier subfield 682 (e.g., three-bit) that may contain Version Identification information, a reserved (Res) subfield 684 (e.g., variable length of to be determined (TBD) bits) that may contain reserved information (e.g., Reserved bits), a Vendor specific subfield 686 (e.g., TBD bits) that may contain Vendor specific information, a multi-AP (MAP) Indication (Ind) subfield 688 (e.g., TBD bits) that may contain MAP Indication information, a reserved (Res) subfield 690 (e.g., TBD bits) that may contain reserved information (e.g., Reserved bits), a Disambiguation (Dis) subfield 692 (e.g., one-bit) that may contain disambiguation information, and a reserved (Res) subfield 694 (e.g., four-bit) that may contain reserved information (e.g., Reserved bits). In some embodiments, the AID 11 subfield 680 has a value of 2047 or any other specific format along with VHT variant indicates “UHR” format. In some embodiments, the Version Identifier subfield 682 (e.g., 3 or TBD-bit) contains a Version Identifier of the NDPA format. In some embodiments, the MAP Indication (Ind) subfield 688 (e.g., TBD-bit) contains information that is used to indicate that the NDPA frame is meant for MAP purposes. In some embodiments, the Disambiguation (Dis) subfield 692 (e.g., 1-bit) contains a Disambiguation bit-bit index=27 as in High Efficiency WLAN (HEW)/EHT STA info format. In some embodiments, the Vendor specific subfield 686 (e.g., TBD bits) contains information that is used to distinguish between different vendors. The number of bits specified here may be used to represent the typical use case. In general, the specified number of bits and its location can change anywhere within this special STA info field (e.g., exception on ‘Disambiguation bit’, and ‘AID11’ field whose locations are fixed). In some embodiments, some fields or combination of fields can be removed from the above definition.

Special STA info field—variation 2

In some embodiments, if/when a UHR device receives an NDPA frame, the UHR device needs to check for STA info field(s) before deciding the NDPA frame as a legacy NDPA frame format. In some embodiments, in condition on the special STA info field, the first STA info field for “UHR” device is in EHT STA info field format.

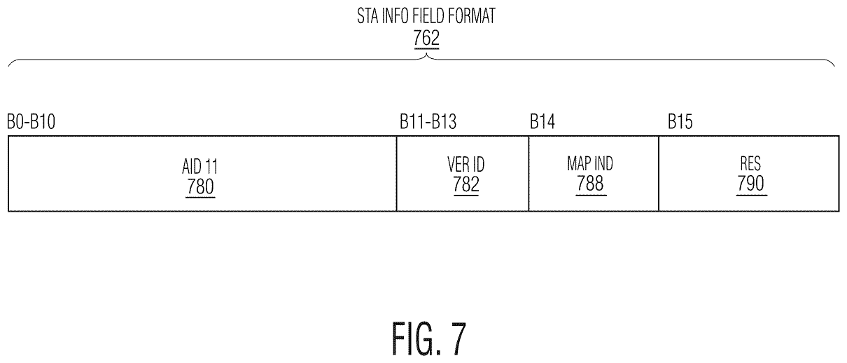

FIG. 7 illustrates a STA info field format 762 in accordance with an embodiment of the invention. The STA info field format 762 illustrated in FIG. 7 may be an embodiment of the first STA info field 462-1 of the NDPA frame format 450 illustrated in FIG. 4. However, the first STA info field 462-1 of the NDPA frame format 450 illustrated in FIG. 4 is not limited to the embodiment shown in FIG. 7. The STA info field format 762 illustrated in FIG. 7 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 7, the STA info field format 762 includes an AID 11 subfield 780 (e.g., eleven-bit) that may contain AID information, a Version Identifier subfield 782 (e.g., three-bit) that may contain Version Identification information, a MAP Indication (Ind) subfield 788 (e.g., one-bit) that may contain MAP Indication information, and a reserved (Res) subfield 790 (e.g., one-bit) that may contain reserved information (e.g., Reserved bit). In some embodiments, the AID 11 subfield 780 has a value of 2047 or any other specific format along with VHT variant indicates “UHR” format. Alternatively, some valid AID11 values, i.e., AID11 value <=2007 is used to indicate the special STA info. In this case, that particular AID11 value is not assigned to any STA. In some embodiments, the Version Identifier subfield 782 (e.g., 3 or TBD-bit) contains a Version Identifier of the NDPA format. In some embodiments, the MAP Indication (Ind) subfield 788 (e.g., TBD-bit) contains information that is used to indicate that the NDPA frame is meant for MAP purposes. In some embodiments, some fields or combination of fields can be removed from the above definition. In some embodiments, a receiver on identifying the special STA info field parses the rest of the NDPA frame with respect to EHT specific STA info field format.

### Special STA Info Field—Variation 3

In some embodiments, if/when a UHR device receives an NDPA frame, the UHR device needs to check for STA info field(s) before deciding the NDPA frame as a legacy NDPA frame format. In some embodiments, in condition on the special STA info field, the first STA info field for “UHR” device is in EHT STA info field format.

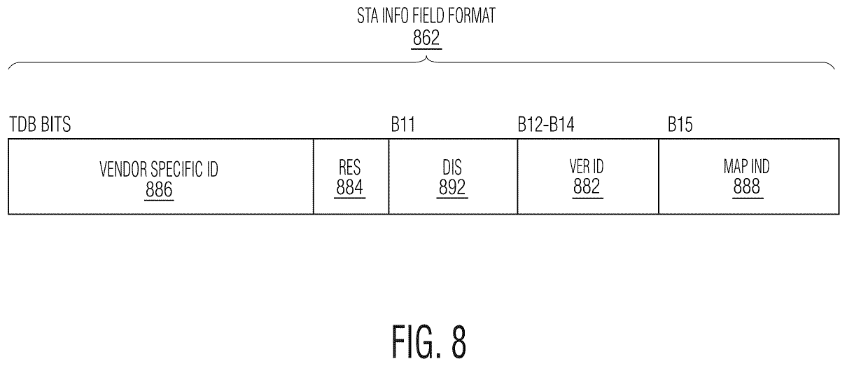

FIG. 8 illustrates a STA info field format 862 in accordance with an embodiment of the invention. The STA info field format 862 illustrated in FIG. 8 may be an embodiment of the first STA info field 462-1 of the NDPA frame format 450 illustrated in FIG. 4. However, the first STA info field 462-1 of the NDPA frame format 450 illustrated in FIG. 4 is not limited to the embodiment shown in FIG. 8. The STA info field format 862 illustrated in FIG. 8 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 8, the STA info field format 862 includes a Vendor specific subfield 886 (e.g., TBD bits) that may contain Vendor specific information, a reserved (Res) subfield 884 (e.g., variable length to be determined (TBD) bits) that may contain reserved information (e.g., Reserved bits), a Disambiguation (Dis) subfield 892 (e.g., one-bit) that may contain disambiguation information, a Version Identifier subfield 882 (e.g., three-bit) that may contain Version Identification information, and a MAP Indication (Ind) subfield 888 (e.g., one bit) that may contain MAP Indication information. In some embodiments, the Disambiguation (Dis) subfield 892 (e.g., 1-bit) contains a Disambiguation bit-bit index=B11 used to indicate the special STA info field. In some embodiments, the Version Identifier subfield 882 (e.g., 3 or TBD-bit) contains a Version Identifier of the NDPA format. In some embodiments, the MAP Indication (Ind) subfield 888 (e.g., TBD bit(s)) contains information that is used to indicate that the NDPA frame is meant for MAP purposes. In some embodiments, the Vendor specific subfield 886 (e.g., TBD bits) contains information that is used to distinguish between different vendors. In some embodiments, some fields or combination of fields can be removed from the above definition. In some embodiments, a receiver on identifying the special STA info field parses the rest of the NDPA frame with respect to EHT specific STA info field format.

### Special STA Info Field—Variation 4

In some embodiments, if/when a UHR device receives an NDPA frame, the UHR device needs to check for STA info field(s) before deciding the NDPA frame as a legacy NDPA frame format. In some embodiments, in condition on the special STA info field, the first STA info field for “UHR” device is in EHT STA info field format.

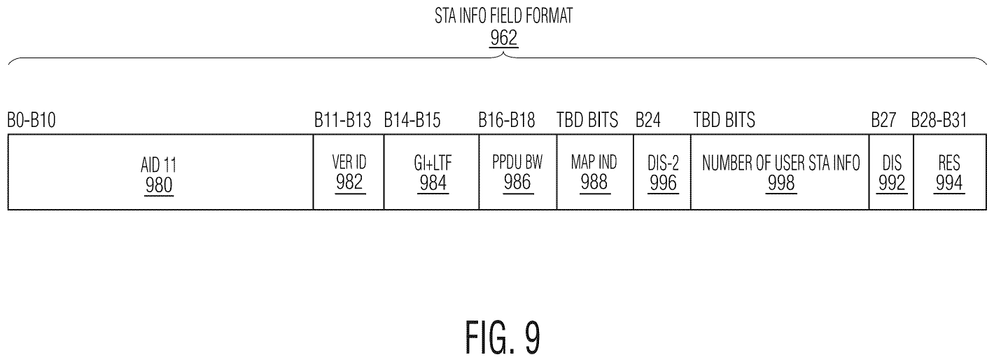

FIG. 9 illustrates a STA info field format 962 in accordance with an embodiment of the invention. The STA info field format 962 illustrated in FIG. 9 may be an embodiment of the first STA info field 462-1 of the NDPA frame format 450 illustrated in FIG. 4. However, the first STA info field 462-1 of the NDPA frame format 450 illustrated in FIG. 4 is not limited to the embodiment shown in FIG. 9. The STA info field format 962 illustrated in FIG. 9 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 9, the STA info field format 962 includes an AID 11 subfield 980 (e.g., eleven-bit) that may contain AID information, a Version Identifier subfield 982 (e.g., three-bit) that may contain Version Identification information, a guard interval and long training field (GI+LTF) subfield 984 (e.g., three-bit) that may contain GI & LTF information, a PPDU bandwidth (BW) subfield 986 (e.g., three-bit) that may contain PPDU BW information, a MAP Indication (Ind) subfield 988 (e.g., TBD bits) that may contain MAP Indication information, a Disambiguation (Dis) subfield 992 (e.g., one-bit) that may contain disambiguation information, a reserved (Res) subfield 994 (e.g., four-bit) that may contain reserved information (e.g., Reserved bits), a second Disambiguation (Dis) Dis-2 subfield 996 (e.g., one-bit) that may contain disambiguation information, and a Number of user STA Info subfield 998 (e.g., TBD bits) that may contain information regarding Number of user STA Info. In some embodiments, the AID 11 subfield 980 has a value of 2047 or any other specific format along with VHT variant indicates “UHR” format. Alternatively, some valid AID11 values, i.e., AID11 value <=2007 is used to indicate the special STA info. In this case, that particular AID11 value is not assigned to any STA. In some embodiments, the Version Identifier subfield 982 (e.g., 3 or TBD-bit) contains a Version Identifier of the NDPA format. In some embodiments, the GI+LTF subfield 984 (e.g., 2-bits) contains information that indicates the GI & LTF used in the subsequent NDP packet transmission. In some embodiments, the MAP Indication (Ind) subfield 988 (e.g., TBD bit(s)) contains information that is used to indicate that the NDPA frame is meant for MAP purposes. In some embodiments, the Disambiguation (Dis) subfield 992 (e.g., 1-bit) contains a Disambiguation bit-bit index=27 as in HEW/EHT STA info format. In some embodiments, the Dis-2 subfield 996 (e.g., 1-bit) contains a Disambiguation-2 1-bit (EHT): Used to spoof for EHT devices with no support for UHR format, which may be set to ‘1’ in bit index=24. The number of bits specified here may be used to represent the typical use case. In general, the specified number of bits and its location can change anywhere within this special STA info field (e.g., exception on ‘Disambiguation bit’, and ‘AID11’ field whose locations are fixed). In some embodiments, some fields or combination of fields can be removed from the above definition.

### Option 1: User STA Info Field

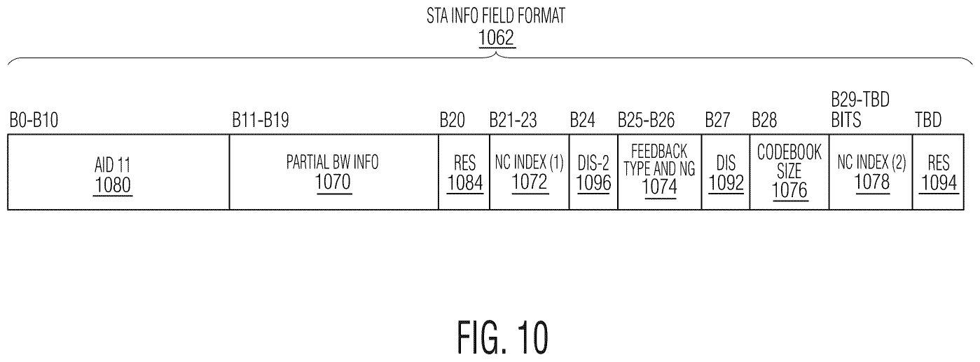

In some embodiments, if/when a UHR device receives an NDPA frame, the UHR device needs to check for STA info field(s) before deciding the NDPA frame as a legacy NDPA frame format. FIG. 10 illustrates a STA info field format 1062 in accordance with an embodiment of the invention that can be used in a UHR NDP Announcement frame. The STA info field format 1062 illustrated in FIG. 10 may be an embodiment of the STA info fields 462-1, . . . , 462-n of the NDPA frame format 450 illustrated in FIG. 4. However, the STA info fields 462-1, . . . , 462-n of the NDPA frame format 450 illustrated in FIG. 4 are not limited to the embodiment shown in FIG. 10. The STA info field format 1062 illustrated in FIG. 10 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 10, the STA info field format 1062 includes an AID 11 subfield 1080 (e.g., eleven-bit) that may contain AID information, a partial bandwidth (BW) info subfield 1070 (e.g., nine-bit) that may contain partial BW information, a reserved (Res) subfield 1084 (e.g., one-bit) that may contain reserved information (e.g., a reserved bit), an Nc (Number of columns) Index subfield 1072 (e.g., three-bit) that may contain Nc index information, a Feedback Type and Ng (Tone/Carrier grouping) subfield 1074 (e.g., two-bit) that may contain Feedback Type and Ng information, a Codebook Size subfield 1076 (e.g., one-bit) that may contain codebook size information, a second Nc Index subfield 1078 (e.g., TBD bits) that may contain Nc index information, a Disambiguation (Dis) subfield 1092 (e.g., one-bit) that may contain disambiguation information, a reserved (Res) subfield 1094 (e.g., TBD bits) that may contain reserved information (e.g., Reserved bits), and a second Disambiguation (Dis) Dis-2 subfield 1096 (e.g., one-bit) that may contain disambiguation information. In some embodiments, the AID 11 subfield 1080 has the same definition as in EHT. In some embodiments, the partial bandwidth BW info subfield 1070 has the same definition as in EHT. In some embodiments, the Nc Index subfield 1072 and the second Nc Index subfield 1078 together form Nc index for UHR devices. In some embodiments, if/when the second Nc Index subfield 1078 is not required, the second Nc Index subfield 1078 will be set as reserved. In some embodiments, the Feedback Type and Ng (Tone/Carrier grouping) subfield 1074 has the same definition as in EHT. In some embodiments, the Codebook Size subfield 1076 has the same definition as in EHT. In some embodiments, the Disambiguation (Dis) subfield 1092 (e.g., 1-bit) contains a Disambiguation bit-bit index=27 as in HEW/EHT STA info format. In some embodiments, the Dis-2 subfield 1096 (e.g., 1-bit) contains a Disambiguation-2 1-bit (EHT): Used to spoof for EHT devices with no support for UHR format, which may be set to ‘1’ in bit index=24. In some embodiments, since the Dis-2 field spoof the EHT STA, the entire structure of STA info field can be changed. An exception may be that Dis-2 & Dis field should be present in bit index=24 and bit index=27, respectively. The Nc Index can be grouped together with rearrangement of other field bits. The number of bits specified here may be used to represent the typical use case. In general, the specified number of bits and its location can change anywhere within this special STA info field (e.g., exception on ‘Disambiguation bit’, and ‘AID11’ field whose locations are fixed). In some embodiments, some fields or combination of fields can be removed from the above definition.

### Option 2:

Currently, three Control subtypes are reserved 0000, 0001, 1111. One of them is defined as Extended control subframe. In some embodiments, an extended subtype field is added in an extended control frame to further indicate that the extended control frame is a new control frame, e.g., enhanced request to send (RTS), enhanced clear to send (CTS), UHR NDPA.

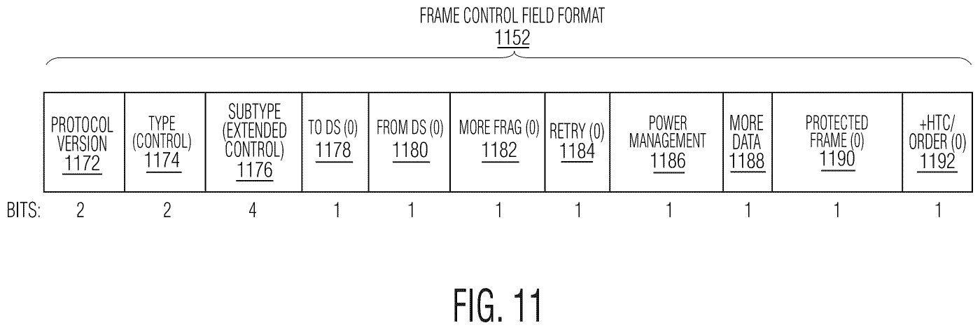

FIG. 11 illustrates a frame control field format 1152 of an extended Control frame. The frame control field format 1152 illustrated in FIG. 11 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 11, the frame control field format 1152 includes a protocol version subfield 1172 (e.g., two-bit) that may contain protocol version information, a type control subfield 1174 (e.g., two-bit) that may contain type control information, a subtype subfield 1176 (e.g., four-bit) that may contain subtype information, a To Distribution System (DS) subfield 1178 (e.g., one-bit) that may contain to DS information, a From DS subfield 1180 (e.g., one-bit) that may contain from DS information, a more fragmentation subfield 1182 (e.g., one-bit) that may contain fragmentation information, a retry subfield 1184 (e.g., one-bit) that may contain retry information, a power management subfield 1186 (e.g., one-bit) that may contain power management information, a more data subfield 1188 (e.g., one-bit) that may contain additional data information, a protected frame subfield 1190 (e.g., one-bit) that may contain frame protection information, and a +HTC (High-Throughput Control) subfield 1192 (e.g., one-bit) that may contain high-throughput control information. In some embodiments, the subtype subfield 1176 contains information, which indicates that the frame control field format 1152 is included or located in an extended control frame. For example, the subtype subfield 1176 contains information, which indicates that an extended subtype field is added in an extended control frame in which the frame control field format 1152 is included or located to further indicate that the extended control frame is a new control frame, e.g., enhanced RTS, enhanced CTS, UHR NDPA. In some embodiments, one of three Control subtypes, 0000, 0001, 1111, is defined as indicating that the frame control field format 1152 is included or located in an extended control frame. In some embodiments, the frame control field format 1152 contains one or more additional subfield with additional information.

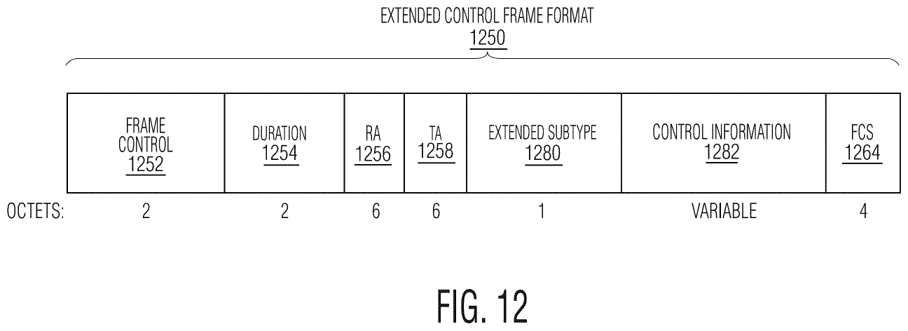

FIG. 12 illustrates an extended control frame format (e.g., a null data packet (NDP) announcement (NDPA) frame format) 1250 in accordance with an embodiment of the invention. The extended control frame format 1250 illustrated in FIG. 12 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 12, the extended control frame format 1250 includes a frame control field 1252 (e.g., two-octet) that may contain frame control information, a frame duration field 1254 (e.g., two-octet) that may contain frame duration information, a RA (receiver address) field 1256 (e.g., six-octet) that may contain RA address information, a TA (transmitter address) field 1258 (e.g., six-octet) that may contain TA address information, an extended subtype field 1280 (e.g., one-octet) that may contain extended subtype information, a control information field 1282 (e.g., variable) may contain control information, and a frame check sequence (FCS) field 1264 (e.g., four-octet) that may contain FCS information. In some embodiments, if/when the control subtype in Frame control indicates an extended control frame, the extended control frame format 1250 represents a full MAC frame format. The frame duration field 1254, the RA field 1256, and the TA field 1258 depicted in FIG. 12 may have the same definition as the frame duration field 454, the RA field 456, and the TA field 458 described with reference to FIG. 4. In some embodiments, the extended subtype field 1280 contains information that is used to indicate the format used in Control information. One such value is used to represent UHR-NDPA.

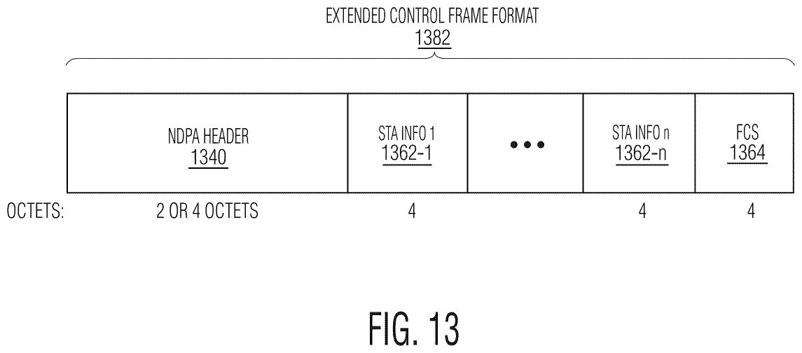

In some embodiments, the extended subtype indicates the UHR-NDPA format. FIG. 13 illustrates a control information field format 1382 in accordance with an embodiment of the invention. The control information field format 1382 illustrated in FIG. 13 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 13, the control information field format 1382 includes an NDPA header 1340 (e.g., two-octet or four-octet) that may contain NDPA header information, one or more STA info field 1362-1, . . . , 1362-n (n being a positive integer) that each (e.g., four-octet) may contain STA information, and a frame check sequence (FCS) field 1364 (e.g., four-octet) that may contain FCS information. In some embodiments, all the four variations of special STA info listed in option 1 can be used as the NDPA header. Some exceptions may include: AID11 field is set to reserved value and/or Dis-ambiguity bit is not required.

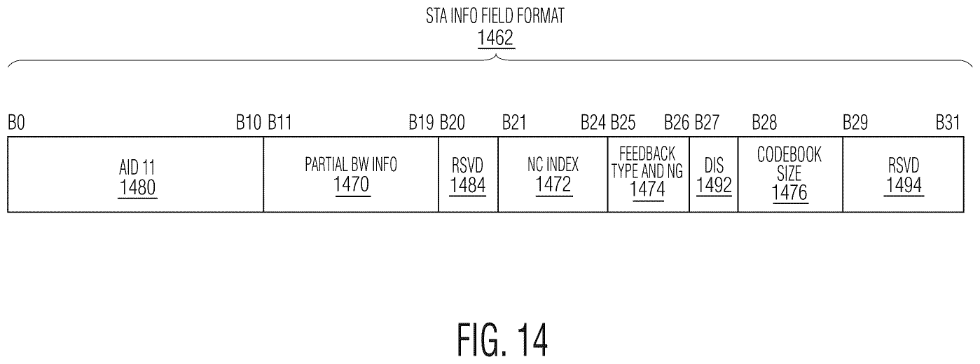

In some embodiments, the STA info field definition is the same as in STA info field format of an EHT NDP announcement frame. FIG. 14 illustrates a STA info field format 1462 in accordance with an embodiment of the invention that can be used in a UHR NDP Announcement frame. The STA info field format 1462 illustrated in FIG. 14 may be an embodiment of the STA info fields 1362-1, . . . , 1362-n of the control information field format 1382 illustrated in FIG. 13. However, the STA info fields 1362-1, . . . , 1362-n of the control information field format 1382 illustrated in FIG. 13 are not limited to the embodiment depicted in FIG. 14. The STA info field format 1462 illustrated in FIG. 14 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 14, the STA info field format 1462 includes an AID 11 subfield 1480 (e.g., eleven-bit) that may contain AID information, a partial bandwidth (BW) info subfield 1470 (e.g., nine-bit) that may contain partial BW information, a reserved (Rsvd) subfield 1484 (e.g., one-bit) that may contain reserved information (e.g., a reserved bit), an Nc Index subfield 1472 (e.g., four-bit) that may contain Nc index information, a Feedback Type and Ng (Tone/Carrier grouping) subfield 1474 (e.g., two-bit) that may contain Feedback Type and Ng information, a Codebook Size subfield 1476 (e.g., one-bit) that may contain codebook size information, a Disambiguation (Dis) subfield 1492 (e.g., one-bit) that may contain disambiguation information, and a reserved (Rsvd) subfield 1494 (e.g., three-bits) that may contain reserved information (e.g., Reserved bits). In some embodiments, some fields or combination of fields can be removed from the above definition.

Some implementations of signaling for MAP, for example, by the wireless communications system 100 depicted in FIG. 1, the multi-link (ML) communications system 200 depicted in FIG. 2, and/or the wireless device 300 depicted in FIG. 3 is described. In some embodiments, a special STA info field is used for indicating the parameters for MAP sounding process. In some embodiments, a special STA info field is the second STA info field with AID11=2047, which can have MAP related parameters for option 1.

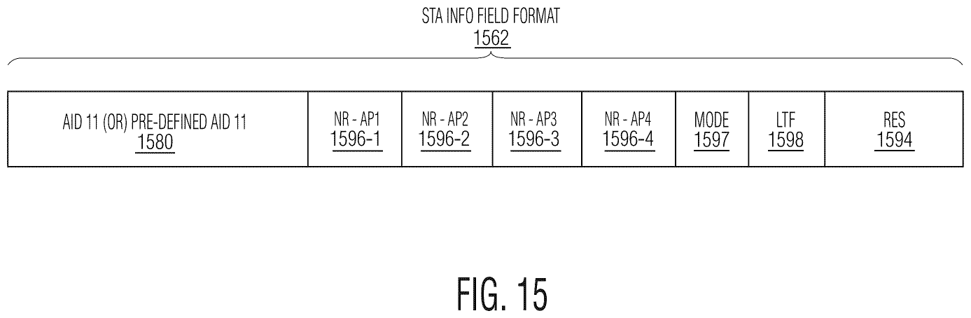

FIG. 15 illustrates a STA info field format 1562 in accordance with an embodiment of the invention. The STA info field format 1562 illustrated in FIG. 15 may be an embodiment of the second STA info field 462-2 of the NDPA frame format 450 illustrated in FIG. 4. However, the second STA info field 462-2 of the NDPA frame format 450 illustrated in FIG. 4 is not limited to the embodiment depicted in FIG. 15. The STA info field format 1562 illustrated in FIG. 15 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 15, the STA info field format 1562 includes an AID 11 subfield 1580 (e.g., eleven-bit) that may contain AID information, an Nr-AP1 subfield 1596-1 that may contain Sounding dimension information of AP1, an Nr-AP2 subfield 1596-2 that may contain Sounding dimension information of AP2, an Nr-AP3 subfield 1596-3 that may contain Sounding dimension information of AP3, an Nr-AP4 subfield 1596-4 that may contain Sounding dimension information of AP4, a mode subfield 1597 that may contain mode information, a LTF subfield 1598 that may contain LTF information, and a reserved (Res) subfield 994 that may contain reserved information (e.g., Reserved bits). In some embodiments, the specified number of bits and its location can change within this special STA info field. In some embodiments, some fields or combination of fields can be removed from the above definition. In some embodiments, MAP indication bits in UHR NDPA frame could represent number of AP participating in the sounding procedure. In some embodiments, if/when the TA address of NDPA represents an MAP Group ID (GID), then AID11 field is 2047 or other defined value, otherwise used to indicate the MAP GID. In some embodiments, Nr-APx (TBD-bit): Sounding dimension of the APx, x is a positive integer. In some embodiments, the order of Nr is with respect to the APs ordering within the MAP group. In some embodiments, Mode (TBD-bit) indicates whether feedback report requested is Joint or sequential. In some embodiments, LTF (TBD-bit) indicates the special LTF option which could be used in MAP NDP packet.

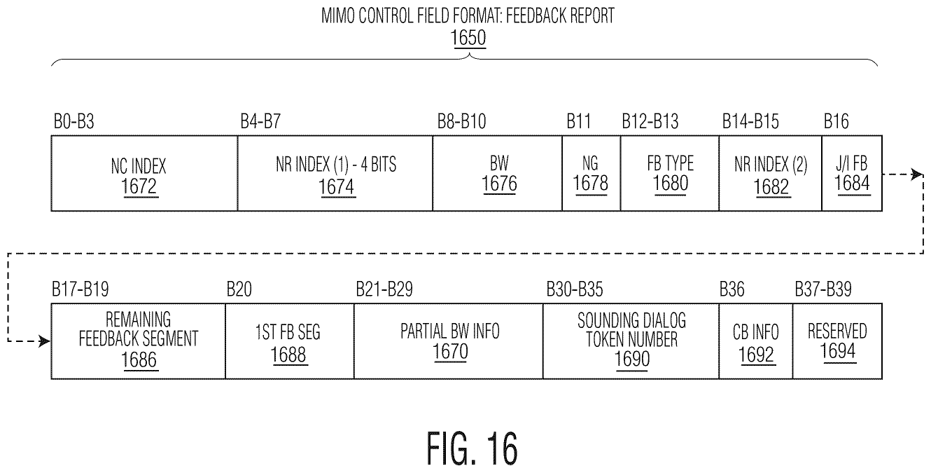

FIG. 16 illustrates a MIMO control field format 1650 in accordance with an embodiment of the invention that can be used as a feedback report. The MIMO control field format 1650 illustrated in FIG. 16 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 16, the MIMO control field format 1650 includes an Nc Index subfield 1672 (e.g., four-bit) that may contain Nc index information, a first Nr Index subfield 1674 (e.g., four-bit) that may contain Nr index information, a bandwidth (BW) subfield 1676 (e.g., three-bit) that may contain BW information, an Ng (Tone/Carrier grouping) subfield 1678 (e.g., one-bit) that may contain Ng information, an FB Type subfield 1680 (e.g., one-bit) that may contain feedback type information, a second Nc Index subfield 1682 (e.g., two-bit) that may contain Nr index information, a Joint Feedback or Sequential feedback (J/S FB) indication subfield 1684 (e.g., one-bit) that may contain J/S feedback information, a remaining feedback segments subfield 1686 (e.g., three-bit) that may contain remaining feedback segment information, a first feedback segment subfield 1688 (e.g., three-bit) that may contain remaining first feedback segment information, a partial bandwidth (BW) info subfield 1670 (e.g., nine-bit) that may contain partial BW information, a sounding dialog token number subfield 1690 (e.g., six-bit) that may contain sounding dialog token number information, a codebook (CB) information subfield 1692 (e.g., one-bit) that may contain CB information, and a reserved (Rsvd) subfield 1694 (e.g., three-bits) that may contain reserved information (e.g., Reserved bits). In some embodiments, J/S FB (1-bit or TBD bit) represents whether the feedback report format is Joint or Sequential. For example, for Joint Feedback report: [Nr Index (1), Nr Index (2)] represent the Sounding dimension of the single Joint feedback report; Nr Index (2): if not required, will set to reserved. In some embodiments, for Sequential Feedback report, each feedback report corresponding to an AP will be preceded by the corresponding MIMO control field. In some embodiments, Nr Index (2) could be a reserved field. Each STA can be triggered only once within the TXOP (same as EHT). In some embodiments, some fields or combination of fields can be removed from the above definition.

In some embodiments, a method of indicating the NDPA frame in UHR for regular single AP operation and multi-AP (MAP) operations along with the MIMO control field definition for MAP operations is provided. In some embodiments, sounding dialog token is used to indicate VHT or being considered as disregard with a special STA info field indicating the frame as UHR-NDPA. In some embodiments, sounding dialog token is used to indicate EHT with a special STA info field indicating the frame as UHR-NDPA. In some embodiments, the reserved control frames are used to create an extended control frame, which further has extended control sub type indicating the presence of UHR-NDPA. In some embodiments, STA info field with Disambiguation-2 bit in bit index 24 to protect against legacy EHT devices. In some embodiments, the fields in the UHR-NDPA contains Version ID, Feedback reduction field along with required parameters, MAP indication. In some embodiments, the special STA info field is the first STA info field. In some embodiments, an additional special STA info field is present based on the MAP indication values of claim 6. In some embodiments, the fields in the MAP related special STA info contain Nr-sounding dimension of all the participating Aps, Mode-mode of MAP scheme to be used, LTF-LTF option being used in NDP packet. In some embodiments, the order of Nr field follows the ordering of the APs when forming the MAP group or any specific ordering of the APs in MAP group, which is known to all participating devices. In some embodiments, the MIMO control field contains extension of the Nr Index [Nr Index (1), Nr Index (2)] to signal for Joint feedback report, with Nr Index (2) being reserved for sequential feedback report. Indication for the request of Joint or sequential feedback report. In some embodiments, the ordering of the feedback report from each STA being: MIMO control field (AP1) followed by Feedback report (AP1), followed by other APs in the group. The ordering of the APs in this field is with respect to the ordering of the APs in the MAP group (known to all devices). In some embodiments, the feedback report can be triggered from each STA only once.

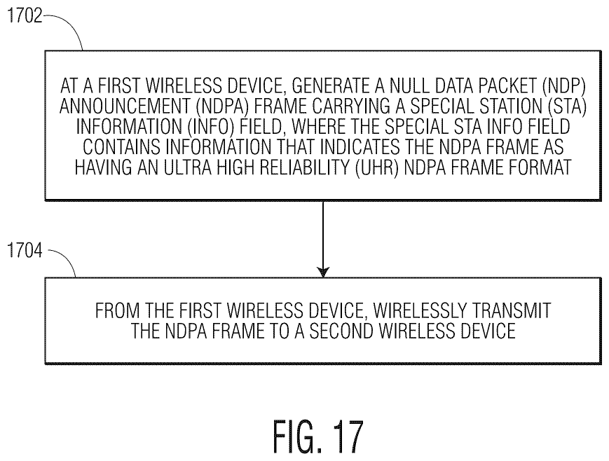

FIG. 17 is a process flow diagram of a method for wireless communications in accordance with an embodiment of the invention. At block 1702, at a first wireless device, a null data packet (NDP) announcement (NDPA) frame carrying a special station (STA) information (info) field is generated, where the special STA info field contains information that indicates the NDPA frame as having an Ultra High Reliability (UHR) NDPA frame format. At block 1704, from the first wireless device, the NDPA frame is wirelessly transmitted to a second wireless device. In some embodiments, the NDPA frame includes STA info fields, and the special STA info field is a first STA info field of the STA info fields. In some embodiments, the NDPA frame further includes a sounding dialog token field, and the sounding dialog token field includes an NDPA variant subfield. In some embodiments, the NDPA variant subfield has a value of 3, which indicates the NDPA frame as having either the UHR NDPA frame format or an Extremely High Throughput (EHT) NDPA frame format. In some embodiments, the NDPA variant subfield has a value of 0, which indicates the NDPA frame as having either the UHR NDPA frame format or a Very High Throughput (VHT) NDPA frame format. In some embodiments, the special STA info field of the NDPA frame is checked by the second wireless device to determine whether the NDPA frame has a legacy NDPA frame format. In some embodiments, the special STA info field includes an Association ID (AID) subfield, a version identifier subfield, a multi-AP (MAP) Indication subfield, and a reserved subfield. In some embodiments, the special STA info field further includes a vendor specific subfield and a Disambiguation (Dis) subfield. In some embodiments, the AID subfield has a value of 2047. In some embodiments, the special STA info field includes a vendor specific subfield, a reserved subfield, a Disambiguation (Dis) subfield, a version identifier subfield, and a multi-AP (MAP) Indication subfield. In some embodiments, the special STA info field includes an AID subfield, a version identifier subfield, a guard interval and long training field subfield, a Physical Layer Protocol Data Unit (PPDU) bandwidth (BW) subfield, a MAP Indication subfield, Disambiguation (Dis) subfields, a reserved subfield, and a Number of user STA Info subfield. In some embodiments, the special STA info field includes an AID subfield, a partial bandwidth (BW) information subfield, a reserved subfield, Number of Column (Nc) Index subfields, a feedback type and Ng (Tone/Carrier grouping) subfield, a codebook size subfield, and Disambiguation (Dis) subfields. In some embodiments, at least one of the first and second wireless devices is compatible with an Institute of Electrical and Electronics Engineers (IEEE) 802.11 protocol. In some embodiments, at least one of the first and second wireless devices is a component of a multi-link device (MLD). At least one of the first and second wireless devices may be the same as or similar to an embodiment of the AP 106 depicted in FIG. 1, the APs 206-1, 206-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate a null data packet (NDP) announcement (NDPA) frame carrying a special station (STA) information (info) field, wherein the special STA info field contains information that indicates the NDPA frame as having an Ultra High Reliability (UHR) NDPA frame format; and
a wireless transceiver configured to wirelessly transmit the NDPA frame to a second wireless device.

2. The wireless device of claim 1, wherein the NDPA frame comprises a plurality of STA info fields, and wherein the special STA info field is a first STA info field of the STA info fields.

3. The wireless device of claim 2, wherein the NDPA frame further comprises a sounding dialog token field, and wherein the sounding dialog token field comprises an NDPA variant subfield.

4. The wireless device of claim 3, wherein the NDPA variant subfield has a value of 3, which indicates the NDPA frame as having either the UHR NDPA frame format or an Extremely High Throughput (EHT) NDPA frame format.

5. The wireless device of claim 3, wherein the NDPA variant subfield has a value of 0, which indicates the NDPA frame as having either the UHR NDPA frame format or a Very High Throughput (VHT) NDPA frame format.

6. The wireless device of claim 1, wherein the special STA info field of the NDPA frame is checked by the second wireless device to determine whether the NDPA frame has a legacy NDPA frame format.

7. The wireless device of claim 1, wherein the special STA info field comprises an Association ID (AID) subfield, a version identifier subfield, a multi-AP (MAP) Indication subfield, and a reserved subfield.

8. The wireless device of claim 7, wherein the special STA info field further comprises a vendor specific subfield and a Disambiguation (Dis) subfield.

9. The wireless device of claim 7, wherein the AID subfield has a value of 2047.

10. The wireless device of claim 1, wherein the special STA info field comprises a vendor specific subfield, a reserved subfield, a Disambiguation (Dis) subfield, a version identifier subfield, and a multi-AP (MAP) Indication subfield.

11. The wireless device of claim 1, wherein the special STA info field comprises an Association ID (AID) subfield, a version identifier subfield, a guard interval and long training field subfield, a Physical Layer Protocol Data Unit (PPDU) bandwidth (BW) subfield, a multi-AP (MAP) Indication subfield, a plurality of Disambiguation (Dis) subfields, a reserved subfield, and a Number of user STA Info subfield.

12. The wireless device of claim 1, wherein the special STA info field comprises an Association ID (AID) subfield, a partial bandwidth (BW) information subfield, a reserved subfield, a plurality of Number of Column (Nc) Index subfields, a feedback type and Tone/Carrier grouping (Ng) subfield, a codebook size subfield, and a plurality of Disambiguation (Dis) subfields.

13. A method for wireless communications, the method comprising:
at a first wireless device, generating a null data packet (NDP) announcement (NDPA) frame carrying a special station (STA) information (info) field, wherein the special STA info field contains information that indicates the NDPA frame as having an Ultra High Reliability (UHR) NDPA frame format; and
from the first wireless device, wirelessly transmitting the NDPA frame to a second wireless device.

14. The method of claim 13, wherein the NDPA frame comprises a plurality of STA info fields, and wherein the special STA info field is a first STA info field of the STA info fields.

15. The method of claim 14, wherein the NDPA frame further comprises a sounding dialog token field, and wherein the sounding dialog token field comprises an NDPA variant subfield.

16. The method of claim 15, wherein the NDPA variant subfield has a value of 3, which indicates the NDPA frame as having either the UHR NDPA frame format or an Extremely High Throughput (EHT) NDPA frame format.

17. The method of claim 15, wherein the NDPA variant subfield has a value of 0, which indicates the NDPA frame as having either the UHR NDPA frame format or a Very High Throughput (VHT) NDPA frame format.

18. The method of claim 13, wherein the special STA info field of the NDPA frame is checked by the second wireless device to determine whether the NDPA frame has a legacy NDPA frame format.

19. The method of claim 13, wherein the special STA info field comprises an Association ID (AID) subfield, a version identifier subfield, a multi-AP (MAP) Indication subfield, and a reserved subfield.

20. The method of claim 19, wherein the special STA info field further comprises a vendor specific subfield and a Disambiguation (Dis) subfield.
